(19) United States
(12) Patent Application Publication
(10) Pub. No.: US 2011/0265614 A1
(43) Pub. Date: Nov. 3, 2011

(54) SUPPORT APPARATUSES FOR HAND-HELD TOOLS

(75) Inventors: Kent D. Christensen, Tucson, AZ (US); Briggs B. Edney, Phoenix, AZ (US)

(73) Assignee: Raytheon Company, Waltham, MA (US)

(21) Appl. No.: 12/771,452

(22) Filed: Apr. 30, 2010

(51) Int. Cl. B25G 1/10

(52) U.S. Cl. 81/489; 16/110.1

(57) ABSTRACT

Embodiments of support apparatuses for hand-held tools are generally described herein. Other embodiments may be described and claimed. In an embodiment, this support apparatus comprises a disk-shaped member having a hole through the disk-shaped member. The disk-shaped member is configured to fit around a hand-held tool having an axial shaft through the hole. The disk-shaped member is oriented substantially perpendicular to the axial shaft and is configured to support a side part of a palm of a hand.

### FIELD

The present disclosure relates generally to tools, and in one embodiment, the disclosure relates to support apparatuses for hand-held tools.

### BACKGROUND

To use any hand-held tool, a user performs a series of motions. For example, a user needs to visually identify the tool, reach for the tool, grasp the tool to position the tool vertically and/or horizontally in space, and if the tool has some type of trigger, the user may need to adjust a position of his hand to be able to press or activate the trigger. Accordingly, there is a large number of motions to operate a hand-held tool and if it is used repeatedly, especially in a manufacturing environment, such repetitive motions may result in the fatigue of the arms, wrists, and hands, which may result in serious injuries, such as carpal tunnel syndrome.

### SUMMARY

In an embodiment, a hand-held tool is provided. This hand-held tool comprises an axial shaft and a handle formed around the axial shaft. Here, the handle is configured to be held by a hand. Attached to the handle is a support member that is oriented substantially perpendicular to the handle and is configured to support a part of the hand.

In another embodiment, a support apparatus is provided. This support apparatus comprises a disk-shaped member having a hole through the disk-shaped member. The disk-shaped member is configured to fit around a hand-held tool having an axial shaft through the hole. The disk-shaped member is oriented substantially perpendicular to the axial shaft and is configured to support a side part of a palm of a hand.

In yet another embodiment, a rotary tool is provided that is configured to be attached to and supported by a retractable tether. The rotary tool comprises an axial shaft that is configured to rotate and comprises a handle formed around the axial shaft. The handle is configured to be held by a hand. The rotary tool also comprises a disk-shaped member attached to the handle and formed around the handle. The disk-shaped member is oriented substantially perpendicular to the handle and is configured to support a side part of a palm of the hand.

### BRIEF DESCRIPTION OF DRAWINGS

The present disclosure is illustrated by way of example and not limitation in the figures of the accompanying drawings, in which like references indicate similar elements and in which:

FIG. 1 depicts an embodiment of a hand-held tool;

FIGS. 2A and 2B depict various embodiments of support members or apparatuses that may be attached to the handle of a tool;

FIG. 3 depicts the use of a hand-held tool with a support member, in accordance with an embodiment of the present invention; and

FIG. 4 depicts the use of a hand-held tool with a different support member, in accordance with an alternate embodiment of the present invention.

### DETAILED DESCRIPTION

The following description and the drawings illustrate specific embodiments of the invention sufficiently to enable those skilled in the art to practice them. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. Embodiments of the invention set forth in the claims encompass all available equivalents of those claims. Embodiments of the invention may be referred to, individually or collectively, herein by the term “invention” merely for convenience and without intending to limit the scope of this application to any single invention or inventive concept if more than one is in fact disclosed.

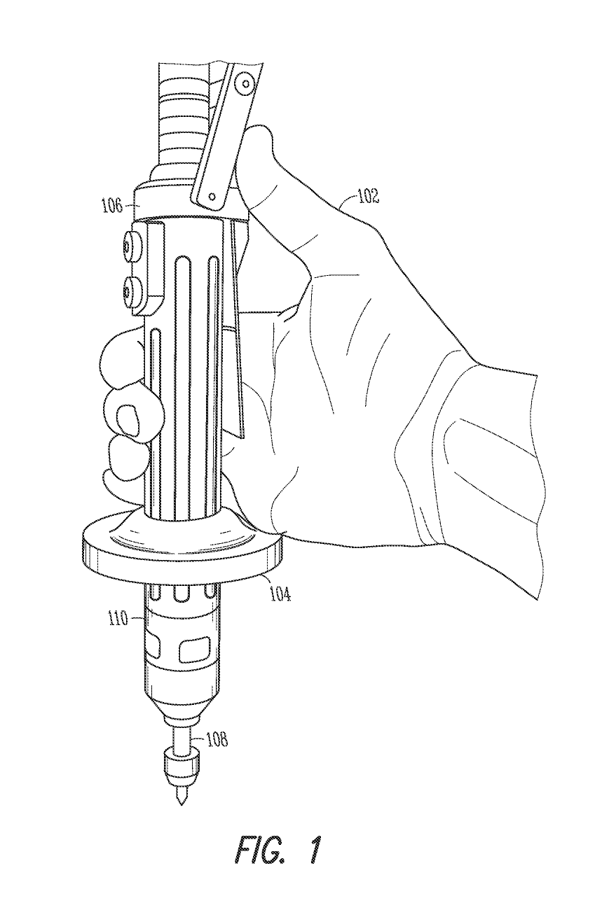

FIG. 1 depicts an embodiment of a hand-held tool 106. As depicted, the hand-held tool 106 is comprised of an axial shaft 108 with a handle 110 that is configured to be held by a hand 102. Attached to the handle 110 is a support member 104. The axial shaft 108 is a straight member that is configured to transmit motion and torque. An example of an axial shaft 108 is a rotating or oscillating round, straight bar for transmitting motion and torque, and may be supported on bearings and carrying gears, wheels, or the like. The handle 110 is a member that is designed or configured to be grasped or held by the hand 102. In embodiments of the present invention, the handle 110 forms around the axial shaft 108. An example of the handle 110 may be a hollow, cylindrical member comprised of rubber, metal, glass, or other material, where the axial shaft 108 is housed within the hollow or cavity of the cylindrical member.

The support member 104 is attached to the handle 110 and is configured to support a part of the hand 102. The support member 104 can have a variety of different shapes, as described and illustrated in detail below, and is oriented substantially perpendicular to the handle 110. In particular, the support member 104 is substantially perpendicular when any part of the support member 104 lies substantially perpendicular to the handle 110. For example, a surface of the support member 104 that supports or makes contact with the part of the hand can be oriented substantially perpendicular to an outer surface of the handle 110. As used herein, the term “substantially” means that the specified dimension may extend within an acceptable tolerance for a given application. In some embodiments, acceptable tolerances range from 70% to 100% of a 90-degree angle.

The hand-held tool 106 may include a variety of different tools. For example, the hand-held tool 106 may be a rotary tool that is configured to rotate. In one example, the axial shaft 108 is configured to rotate while the handle 110 remains stationary. Examples of such hand-held tools include torque drivers, drills, and other rotary tools used for grinding, drilling, sharpening, cutting, cleaning, polishing, sanding, routing, carving, engraving, and other functionalities. In another example, the handle 110 may be fixed to the axial shaft 108 and accordingly, the handle 110 rotates with the axial shaft 108. A screwdriver is an example of such a hand-held tool with a fixed axial shaft 108.

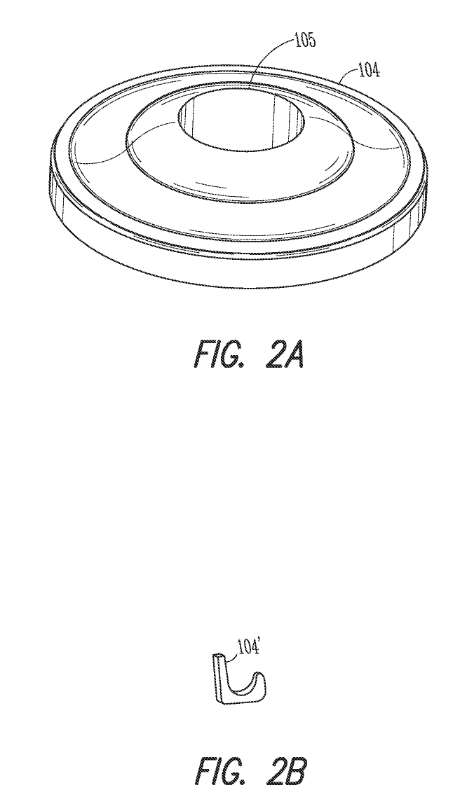

FIGS. 2A and 2B depict various embodiments of support members or apparatuses that may be attached to the handle of a tool. The support member is configured to support one or more parts of a hand, such as a bottom portion of a palm or a finger, and can have a variety of different shapes. In one embodiment, as depicted in FIG. 2A, the support member 104 is disk-shaped. As used herein, a “disk-shaped” member is a flat or a curved member with a circular profile or other round profiles. As depicted in FIG. 2A, the disk-shaped support member 104 has a circular profile, but in an alternate embodiment, the disk-shaped support member 104 may also have an elliptical profile.

In the embodiment depicted in FIG. 2A, the disk-shaped support number 104 is configured to fit around a hand-held tool through a hole 105. Particularly, the disk-shaped member 104 has a hole 105 through its center or at other locations, and a handle of the hand-held tool is configured to fit through this hole 105. In one embodiment, the disk-shaped member 104 may be detachable from the handle of the hand-held tool. Here, the disk-shaped support member 104 may be formed separately from the hand-held tool and attached to the hand-held tool through the hole 105 when needed. The disk-shaped support member 104 may attach to the hand-held tool by an interference fit (or friction fit). Alternatively, the disk-shaped support member 104 may be attached to the hand-held tool with a fastener or may be formed as a part of the handle itself.

As illustrated in FIG. 1, the disk-shaped support member 104 depicted in FIG. 2A is configured to support a side part of a palm of a hand. As depicted in FIG. 2A, a surface of the disk-shaped support member 104 may be curved, in accordance with one of many embodiments, to possibly provide a secure fit with the side part of a palm, where the hand is held substantially perpendicular to a wrist. One or more surfaces of the disk-shaped support member 104 may also be sloped, tapered, flat, or have a variety of other different shapes. Additionally, in one embodiment, one or more surfaces of the disk-shaped support member 104 may, in one embodiment, have a textured surface that results in increased friction between the textured surface and a part of the hand in contact with the textured surface when compared to a smooth surface. Accordingly, the textured surface may possibly, for example, reduce the likelihood of the hand slipping away from the disk-shaped support member 104 or the tool itself.

FIG. 2B illustrates another embodiment of a support member 104′ that is hook-shaped. As used herein, a “hook-shaped” member is a curved or angular member. This hook-shaped support member 104′ is configured to attach to a handle of a tool and is configured to support a bottom portion of a finger, which is illustrated in more detail below. The hook-shaped support member 104′ may be attached to the hand-held tool with a fastener or may be formed as a part of the handle itself. In addition to the above-referenced disk-shaped and hook-shaped support members, a support member can also have a variety of other different shapes, such as an L-shape, a flat member having a triangular profile, or a toroid shape.

It should be appreciated that the support member 104 (and 104′) may be comprised of a variety of different materials, such as a urethane material. Examples of urethane materials include urethane elastomer and cast urethane. In one embodiment, a hardness of the urethane material is between 30 Durometers and 90 Durometers. Alternatively, the hardness of the urethane material can be between 70 Durometers and 90 Durometers. Other examples of materials include rubber, plastic, wood, metal, and other materials.

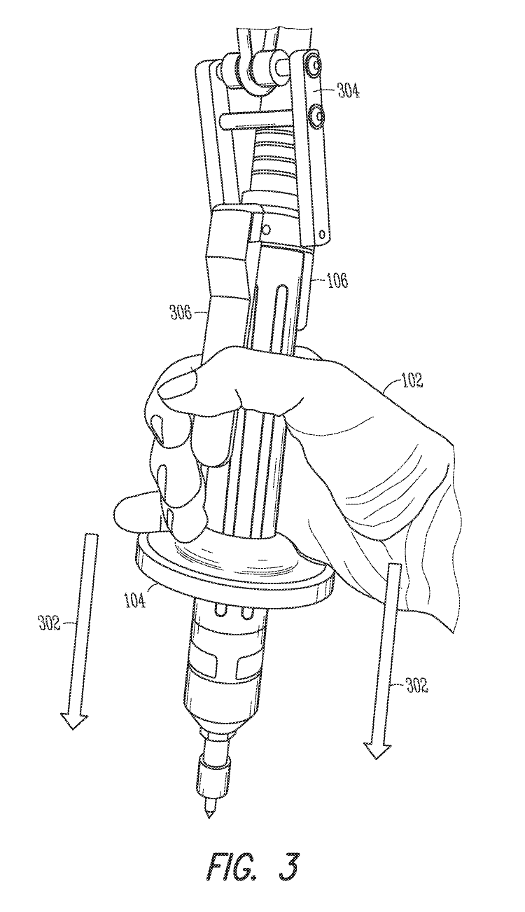

FIG. 3 depicts the use of a hand-held tool 106 with a support member 104, in accordance with an embodiment of the present invention. Here, the hand-held tool 106 is attached to and supported by a retractable tether 304, which is a flexible restraint for holding the hand-held tool 106 in place, allowing a short radius in which the hand-held tool 106 can move about. The hand-held tool 106 also includes a trigger 306 that, when pressed, activates a functionality of the hand-held tool 106.

In this embodiment, the support member 104 as attached to the hand-held tool 106 is disk-shaped and is configured to support a side part of a palm of the hand 102. The hand (or part of the hand) has a weight and, when supported by the support member 104, the weight exerts a force on the hand-held tool 106 along a direction 302 parallel to the axial shaft of the hand-held tool 106. As a result, in this example, the hand 102 does not need to grip the hand-held tool 106 to push the hand-held tool 106 down. As depicted, the hand 102 may rest on the support member 104 to exert a downward force on the hand-held tool 106. Furthermore, since the hand 102 is attached to an arm, the weight of the arm may also exert a downward force on the hand-held tool 106 along direction 302, without the hand 102 gripping the tool 106.

Without the need to grip the hand-held tool 106 to exert a downward force, the use of the disk-shaped support member 104 (or other types of support members) may possibly reduce the number of hand motions to use the hand-held tool 106. Accordingly, the elimination or reduction of the gripping force by the hand may, for example, possibly prevent user fatigue in the arm, wrist, and hand, and therefore may possibly prevent repetitive motion injuries in the hand, wrist, and/or arm. Furthermore, the disk-shaped support member 104 may also reduce the need for a user to further adjust the position of his hand to activate, for example, the trigger 306. By resting the hand 102 on the disk-shaped support member 104, the hand 102 is placed at the right position such that at least one finger of the hand 102 is located proximately to the trigger 306.

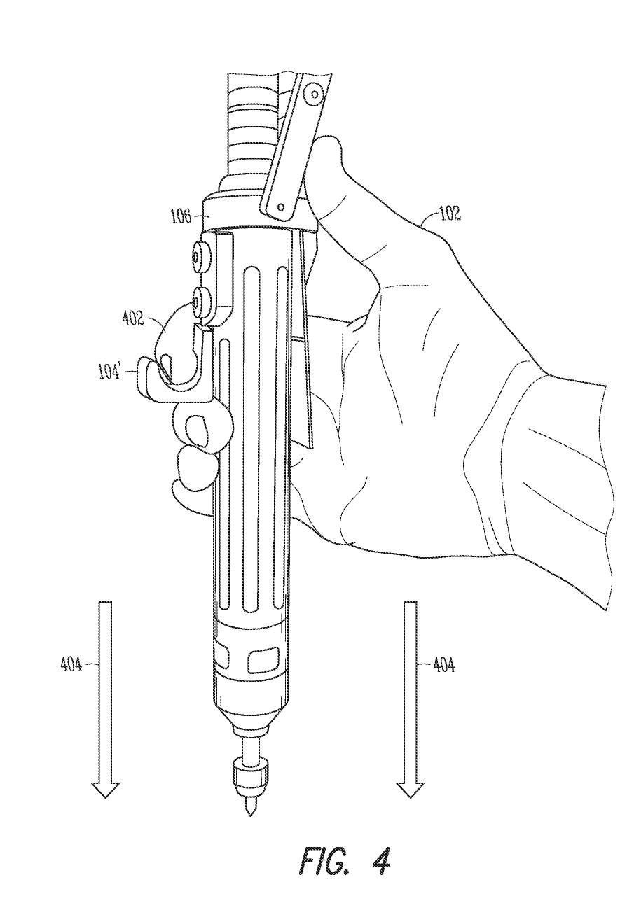

FIG. 4 depicts the use of a hand-held tool 106 with a different support member 104′, in accordance with an alternate embodiment of the present invention. In this embodiment, the support member 104′ as attached to the hand-held tool 106 is hook-shaped and is configured to support a finger 402 of the hand 102. Similarly, the finger 402 has a weight and, when supported by the support member 104′, the weight exerts a force on the hand-held tool 106 along a direction 404 parallel to the axial shaft of the tool 106. Furthermore, since the finger 402 is a part of the hand 102, and the hand 102 is attached to an arm, the weight of the hand 102 and arm may also exert some downward force on the tool 106 along direction 404, without the hand 102 gripping the tool 106.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, the invention may lie in less than all features of a single disclosed embodiment. Thus, the following claims are hereby incorporated into the detailed description, with each claim standing on its own as a separate preferred embodiment.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A rotary tool configured to be attached to and supported by a retractable tether, the rotary tool comprising:
an axial shaft that is configured to rotate;
a handle formed around the axial shaft, the handle being configured to be held by a hand; and
a disk-shaped member attached to the handle, the disk-shaped member being formed around the handle, being oriented substantially perpendicular to the handle, and being configured to support a side part of a palm of the hand.

2. The rotary tool of claim 1, wherein the disk-shaped member is detachable from the handle.

3. The rotary tool of claim 1, wherein the hand is attached to an arm, and wherein a weight of the hand and the arm exerts a force on the tool along a direction parallel to the axial shaft when the side part of the palm of the hand is supported by the disk-shaped member.

4. The rotary tool of claim 1, wherein the disk-shaped member has a textured surface.

5. The rotary tool of claim 1, wherein the disk-shaped member comprises a urethane material.

6. The rotary tool of claim 5, wherein the urethane material has a hardness between 70 Durometers and 90 Durometers.

7. A hand-held tool comprising:
an axial shaft;
a handle formed around the axial shaft, the handle being configured to be held by a hand; and
a support member attached to the handle, the support member being oriented substantially perpendicular to the handle and being configured to support a part of the hand.

8. The hand-held tool of claim 7, wherein the part of the hand has a weight, and wherein the weight exerts a force on the tool along a direction parallel to the axial shaft when the part of the hand is supported by the support member.

9. The hand-held tool of claim 7, wherein the tool is a rotary tool, and wherein the axial shaft is configured to rotate.

10. The hand-held tool of claim 7, wherein the tool is attached to and supported by a retractable tether.

11. The hand-held tool of claim 7, wherein the part is a side part of the palm of the hand.

12. The hand-held tool of claim 7, wherein the part is a bottom portion of a finger of the hand.

13. The hand-held tool of claim 7, wherein the support member is disk-shaped and has a hole through a center of the support member, and wherein the handle is configured to fit through the hole.

14. The hand-held tool of claim 7, wherein the support member is hook-shaped.

15. A support apparatus comprising a disk-shaped member having a hole through the disk-shaped member, the disk-shaped member being configured to fit around a hand-held tool having an axial shaft through the hole, the disk-shaped member being oriented substantially perpendicular to the axial shaft and being configured to support a side part of the palm of a hand.

16. The support apparatus of claim 15, wherein the disk-shaped member comprises a urethane material.

17. The support apparatus of claim 16, wherein the urethane material has a hardness between 30 Durometers and 90 Durometers.

18. The support apparatus of claim 15, wherein the disk-shaped member has a textured surface.

19. The support apparatus of claim 15, wherein the disk-shaped member has a circular profile.

20. The support apparatus of claim 15, wherein the disk-shaped member has an elliptical profile.
